(19) United States
(12) Patent Application Publication
(10) Pub. No.: US 2004/0027331 A1
(43) Pub. Date: Feb. 12, 2004

(54) Pointing device and electronic apparatus provided with the pointing device

(75) Inventors: Isao Mochizuki, Kaizu-gun (JP); Hiroyasu Yano, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/629,608

(22) Filed: Jul. 30, 2003

(30) Foreign Application Priority Data
Aug. 8, 2002 (JP) 2002-231116

(51) Int. Cl. G09G 5/08

(52) U.S. Cl. 345/161

(57) ABSTRACT

In a pointing device (1), strain sensors (7A-7D) are formed on a sensor substrate (2) at positions partially overlapping with a lower surface of a fixed part (5) of a stick member (3) so that a portion of the substrate (2) in which the largest stress concentrates by operation of an operating part (4) of the stick member (3) overlaps with each strain sensor (7A-7D). When such pointing device 1 is installed on a notebook-sized personal computer (20), the stick member (3) is operated to move a cursor (K) displayed on a liquid crystal display (23). Accordingly, the cursor (K) can accurately be moved by operation of the stick member with good operationality.

### BACKGROUND OF THE INVENTION

1. Field of the Invention

The present invention relates to a pointing device which is operated to move a pointer or cursor to an arbitrary position on a display of an electronic apparatus such as a personal computer or the like, and more particularly, to a pointing device capable of detecting an operation state of a stick member provided in the pointing device with high sensitivity and an electronic apparatus provided with the pointing device.

2. Description of Related Art

Heretofore, when a desktop personal computer or the like is set up and used on a desk, there is usually an area or space enough to use a mouse on the desk. The mouse is thus operated on a pad to move a cursor or pointer displayed on a display.

On the other hand, when a small-sized electronic apparatus such as a notebook-sized personal computer or the like is used in a portable condition, there is no area to allow a user to use a mouse in many cases. Accordingly, a pointing device is provided in a keyboard of the small-sized electronic apparatus, and a stick member of the pointing device is operated by a user's finger to move a cursor or pointer displayed on a display.

The pointing device of this type has variously been proposed in the prior art. For example, such pointing device is disclosed in Japanese patent unexamined publications Nos. Hei 7-174646 and 8-87375.

Japanese patent unexamined publication No. Hei 7-174646 discloses a pointing device provided with an upright operating part placed on an elastic plate and four strain resistance elements arranged around the operating part at four symmetrical places on two orthogonal lines each joining two of fixed parts while passing through the operating part. When a user applies a force on the operating part by his finger, deforming an elastic plate, the force applied on the operating part is detected based on a change in the resistance value of each strain resistance element.

Furthermore, Japanese patent unexamined publication No. Hei 8-87375 discloses a pointing device provided with a substrate having an upper surface on which a stick part is formed and a lower surface on which four strain gauges are arranged around the stick part at 90° angular intervals. This substrate is secured by screws to a base so that the strain gauges face a recess of the base. This device is constructed to detect a displacement direction and a displacement quantity of a tip end of the stick part based on a change in the resistance value of each strain gauge during operation of the stick part.

In the pointing devices constructed as above, the resistance values of the strain resistance detection elements or the strain gauges are changed by deformation of the elastic plate or the substrate in response to the operation on the operating part or the stick part with user's finger. Based on the changes in those resistance values, the operation state (the displacement direction and the displacement quantity) of the operating part or the stick part is detected for control of the cursor or pointer to be moved on the display.

Analyzing a relationship between the displacement quantities of the operating part and the stick member of the pointing devices operated and the changes in the resistance values of the strain resistance detection elements and the strain gauges, the changes in the resistance values of the strain resistance detection elements and the strain gauges are small as compared with the displacement quantities of the operating part and the stick member. In this regard, the above pointing devices are still insufficient in detecting sensitivity.

This is expected to be caused by the following reasons. The above pointing devices have a structural restriction that the elastic plate or the substrate is deformed, thereby indirectly deforming the strain resistance detection elements or the strain gauges, and the changes in the resistance values are detected to detect the displacement quantity of the operating part or the stick part. In the pointing device disclosed in Japanese patent unexamined publication No. Hei 7-174646, furthermore, if focusing attention on a placement relationship between the four strain resistance detection elements and the operating part on the elastic plate, each strain resistance detection element is placed apart from a lower end of the operating part. In the pointing device in Japanese patent unexamined publication No. Hei 8-87375, similarly, if focusing attention on a placement relationship between the four strain gauges and the stick part on the substrate, each strain gauge is placed apart from a lower end of the stick part.

Consequently, the inventors of the present invention have studied the above problems and measured a distribution of stress generated in the elastic plate and the substrate around the operating part and the stick part during operation, and found that the stress concentrated at positions close to the lower ends of the operating part and the stick part and thus achieved the present invention.

### SUMMARY OF THE INVENTION

The present invention has been made in view of the above circumstances and has an object to overcome the above problems and to provide a pointing device capable of detecting an operation state of a stick member provided in a pointing device with high sensitivity and an electronic apparatus provided with the pointing device.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a pointing device including: a sensor substrate; a stick member including a base part and being arranged upright on the sensor substrate; and a pair of strain sensors for detecting an operating state of the stick member, the strain sensors being provided on the sensor substrate at positions where a part of each strain sensor overlaps with a lower surface of the base part of the stick member.

In the above pointing device, the pair of strain sensors are placed in partially overlapping relation with the lower surface of the base part of the stick member. Accordingly, a portion of the sensor substrate in which the largest stress concentrates by operation of the stick member overlaps with each strain sensor. This makes it possible to directly exert the stress generated in the sensor substrate on each strain sensor. Consequently, the operation state of the stick member can be detected with high sensitivity through each strain sensor.

Preferably, the above pointing device further includes trimmable chip resistors each being connected in series with each strain sensor.

In the above pointing device, the trimmable chip resistors are connected in series with the strain sensors respectively. Even where there are changes in the resistance values of the strain sensors, the change in offset voltage caused by the changes in the resistance values of the strain sensors can be canceled by trimming the chip resistors.

According to another aspect of the present invention, there is provided an electronic apparatus including: a main unit on which a keyboard is mounted; a display part which is connected with an edge of the main unit so that the display part is opened/closed with respect to the main unit; and a pointing device for moving a cursor displayed on the display part, the pointing device being arranged in the keyboard of the main unit; wherein the pointing device includes a sensor substrate; a stick member including a base part and being arranged upright on the sensor substrate; and a pair of strain sensors for detecting an operating state of the stick member, the strain sensors being provided on the sensor substrate at positions where a part of each strain sensor overlaps with a lower surface of the base part of the stick member.

In the above electronic apparatus, including the pointing device as mentioned above, the portion of the sensor substrate in which the largest stress concentrates by operation of the stick member overlaps with the strain sensors as in the above case. Thus, the stress caused in the sensor substrate is allowed to directly act on the strain sensors. This makes it possible to detect the operation state of the stick member with high sensitivity through each strain sensor. The cursor or the like displayed on the display part can be moved accurately by operation of the stick member with good operationality.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a schematic perspective view of a pointing device in an embodiment;

FIG. 2 is a schematic plane view of the pointing device;

FIG. 3 is a side view of the pointing device;

FIG. 4 is an explanatory view showing a connecting relation between strain sensors and chip resistors;

FIG. 5 is an explanatory view schematically showing a deformed state of a sensor substrate, caused by operation of a stick in a direction +X of an X-axis;

FIG. 6 is an explanatory view schematically showing a stress distribution in the sensor substrate, induced by operation of the stick in the direction +X of the X-axis;

FIG. 7 is a perspective view of a notebook-sized personal computer;

FIG. 8 is a block diagram of the notebook-sized personal computer; and

FIG. 9 is an enlarged sectional view showing the pointing device mounted on a key switch arrangement plate in the notebook-sized personal computer.

### DETAILED DESCRIPTION OF THE PREFERRED EMBODIMENTS

A detailed description of a preferred embodiment of a pointing device and an electronic apparatus provided with it, namely, a notebook-sized personal computer, embodying the present invention will now be given referring to the accompanying drawings.

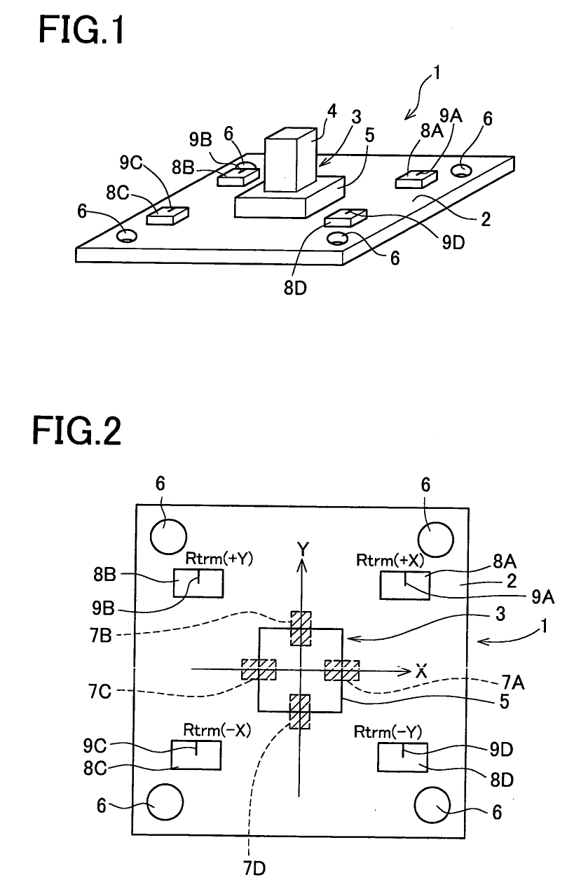

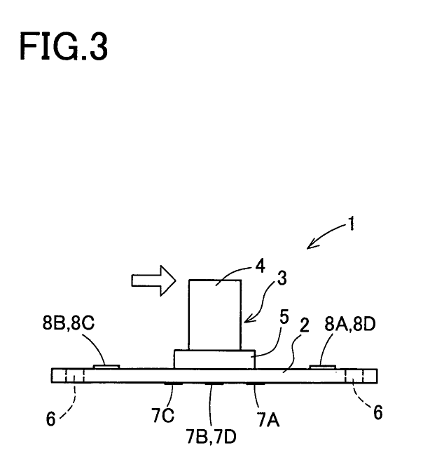

A schematic structure of the pointing device in the present embodiment is first described with reference to FIGS. 1 through 3. FIG. 1 is a schematic perspective view of the pointing device. FIG. 2 is a schematic plane view of same. FIG. 3 is a side view of same.

In FIG. 1, a pointing device 1 includes a sensor substrate 2 having substantially a square shape in plane view, on which a stick 3 is provided upright at almost the center position of the sensor substrate 2.

The stick 3 is constituted of an operating part 4 having a rectangular column shape and a fixed part 5 having a square shape under the operating part 4, which are integrally molded of ceramics. This stick 3 is secured onto the sensor substrate 2 by adhesive.

The sensor substrate 2 is made of a flexible insulating material to which printed-wiring can be applied. A preferable insulating material forming the sensor substrate 2 is a glass epoxy resin. Besides this, the sensor substrate 2 may be made of a metallic plate such as an enameled metallic substrate formed with an insulating film, ceramics, and the like. At four corners of the substrate 2, holes 6 are formed to secure the substrate 2 by screws to a reinforcing plate 34 mentioned later.

The sensor substrate 2 is further formed, on the under surface, with four strain sensors 7A, 7B, 7C, and 7D each having a rectangular shape as shown in FIGS. 2 and 3. These strain sensors 7A-7D are arranged so that the four edges of the lower surface of the fixed part 5 of the stick 3 substantially bisect the rectangular strain sensors 7A-7D respectively, as shown in FIG. 2. Thus, about the half of each strain sensor 7A-7D overlaps with the lower surface of the fixed part 5 through the sensor substrate 2.

Each strain sensor 7A-7D is made of a resistance material predominantly including ruthenium dioxide or carbon, of which a resistance value changes depending on stress. Such material is adhered to the sensor substrate 2 by use of a film-forming technique such as vacuum deposition, spattering, vapor-phase growth, etc.

In the case where the sensor substrate 2 is made of glass epoxy resin and the strain sensors 7A-7D are made of the resistance material predominantly including carbon, the strain sensors 7A-7D can be formed at temperatures below a heat-resistant temperature of the sensor substrate 2. Alternatively, the strain sensors 7A-7D can also be formed by a printing technique using conductive ink or a photoengraving technique such as photolithography, etching, etc.

The strain sensors 7A-7D are arranged at 90° angular intervals about the stick 3, as shown in FIG. 2; specifically, they are positioned on the +X side of the X-axis, the +Y side of the Y-axis, the −X side of the X-axis, and the −Y side of the Y-axis, in this order. The strain sensors 7A-7D are formed to be axially symmetric in shape and thickness with respect to the X-axis or the Y-axis, so that the strains generated symmetrically in each sensor with respect to each axis can be canceled each other.

The sensor substrate 2 is formed, on the upper surface, with trimmable chip resistors 8A, 8B, 8C, and 8D at positions outside apart from the strain sensors 7A-7D respectively. Since each chip resistor 8A-8D is disposed outside apart from each strain sensor 7A-7D and is formed with a thicker than each strain sensor 7A-7D, a resistance value of each chip resistor will not change even when the sensor substrate 2 is deformed by operation of the stick 3 as mentioned later. Furthermore, each chip resistor 8A-8D is formed with a notch 9A-9D by a trimming operation of irradiating a laser beam to a resistance area of each chip resistor by a predetermined length from one edge toward the other edge. Each notch 9A-9D is used to regulate the resistance value of each chip resistor 8A-8D, In each chip resistor 8A-8D, the resistance area except for a portion corresponding to each notch 9A-9D acts as a resistance area which provides an effective resistance value.

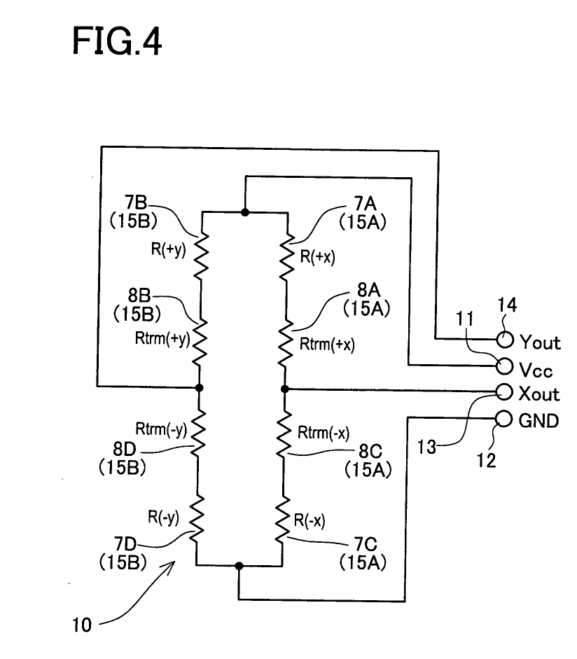

The strain sensors 7A-7D are directly connected with the chip resistors 8A-8D respectively. Assuming that the resistance values of the strain sensors 7A-7D are expressed by R(+X), R(+Y), R(−X), and R(−Y) respectively and the resistance values of the chip resistors 8A-8D obtained after the trimming operation are expressed by Rtrm(+X), Rtrm(+Y), Rtrm(−X), and Rtrm(−Y) respectively, the electrically connecting relation between each strain sensor 7A-7D and each chip resistor 8A-8D is shown as in FIG. 4.

FIG. 4 is an explanatory view showing the connecting relation between the strain sensors 7A-7D and the chip resistors 8A-8D, which constitute a bridge circuit 10.

More specifically, a power supply terminal (Vcc) 11 to which a power supply voltage of for example 5V is applied is connected between the strain sensors 7A and 7B. A GND terminal 12 is connected between the strain sensors 7C and 7D. An X-axis output terminal (Xout) 13 is connected between the chip resistors 8A and 8C. A Y-axis output terminal (Yout) 14 is connected between the chip resistors 8B and 8D. In the bridge circuit 10 constructed of those strain sensors 7A-7D and the chip resistors 8A-8D, a pair of the strain sensors 7A and 7C arranged on the X-axis, the chip resistors 8A and 8C, and the X-axis output terminal 13 construct an X-side transducer 15A which detects a displacement quantity on the X-axis, and a pair of the strain sensors 7B and 7D arranged on the Y-axis, the chip resistors 8B and 8D, and the Y-axis output terminal 14 construct a Y-side transducer 15B which detects a displacement quantity on the Y-axis. In addition, the transducers 15A and 15B serve in combination as a Z-side transducer which detects a strain quantity in the Z-axis direction based on a combination of the outputs of the transducers 15A and 15B.

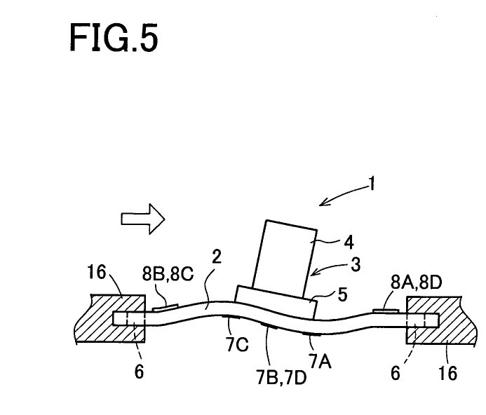

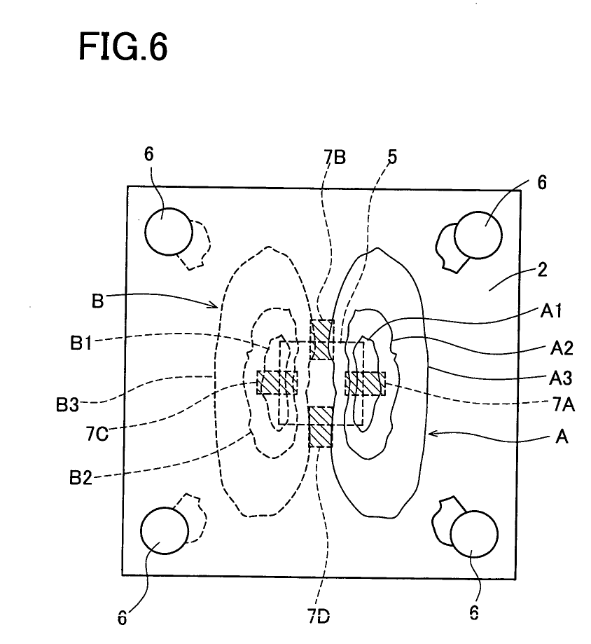

The operation of the pointing device 1 constructed as above is explained with reference to FIGS. 5 and 6. FIG. 5 is an explanatory view schematically showing a deformed state of the sensor substrate 2 which is caused when the stick 3 is operated in the direction +X of the X-axis. FIG. 6 is an explanatory view schematically showing a distribution of the stress generated in the sensor substrate 2 by operation of the stick 3 in the direction +X of the X-axis.

As shown in FIG. 3, at first, while no pressure (force) is applied on the stick 3 and the operating part 4, each strain sensor 7A-7D being disposed axial-symmetrically about the X-axis or the Y-axis (see FIG. 2), the resistance value remains unchanged. Accordingly, the signal outputs at the X-axis output terminal 13 (the X-side transducer 15A) and the Y-axis output terminal 14 (the Y-side transducer 15B) in the bridge circuit 10 are maintained at predetermined voltages. Thus, a cursor K displayed on a liquid crystal display (LCD) 23 of a notebook-sized personal computer 20 mentioned later is not moved.

The following explanation is made on a distribution of the stress to be generated in the sensor substrate 2 when pressure is applied on the stick 3 and the operating part 4, referring to FIGS. 5 and 6. As shown in FIG. 5, when pressure is applied on the stick 3 and the operating part 4 so as to tilt the stick 3 in the direction +X of the X-axis in a state where both ends of the sensor substrate 2 are fixed by a fastening device 16, the sensor substrate 2 warps downward on the +X side (the right side) and upward on the −X side (the left side) at the same time.

At this time, in the sensor substrate 2, a stress distribution around the fixed part 5 of the stick 3 is caused as shown in FIG. 6. In FIG. 6, in a distribution contour A (solid line) of the stress generated on the +X side, an innermost contour A1 indicates an area under the largest stress and other contours A2 and A3 indicate areas under smaller stresses in order. The center of the area defined by the contour A1 in which the large stress is generated is close to a position where the lower surface of the fixed part 5 and the center portion of the strain sensor 7A indirectly overlap. Furthermore, the contours A2 and A3 are distributed around the area defined by the contour A1. This shows that the strain sensor 7A is placed in a position at which the largest stress concentrates. Accordingly, the stress caused in the sensor substrate 2 can directly be exerted on the strain sensor 7A. This makes it possible to detect the operation state of the stick 3 through the strain sensor 7A with high sensitivity.

In a distribution contour B (dotted line) of the stress generated on the −X side, the innermost contour B1 indicates an area under the largest stress and other contours B2 and B3 indicate areas under smaller stresses in order. The center of the area defined by the contour B1 in which the large stress is generated is close to a place where the lower surface of the fixed part 5 and the center portion of the strain sensor 7C overlap. Furthermore, the contours B2 and B3 are distributed around the area defined by the contour B1. This shows that the strain sensor 7C is placed in a position at which the largest stress concentrates. Accordingly, the stress generated in the sensor substrate 2 can directly be exerted on the strain sensor 7C. This makes it possible to detect the operation state of the stick 3 through the strain sensor 7C with high sensitivity.

Although the above explanation is made on the distribution of the stress caused in the sensor substrate 2 by operating, or tilting, the stick 3 in the direction +X of the X-axis, it is also obvious that the same stress distribution is produced when the stick 3 is operated in the direction −X. Similarly, the same stress distribution is produced when the stick 3 is operated in the directions +Y and −Y respectively. At this time, the center of the area in which the largest stress is generated is close to a place where the lower surface of the fixed part 5 overlaps with the center portion of the strain sensor 7B and a place where the lower surface of the fixed part 5 overlaps with the center portion of the strain sensor 7D, and the stresses are distributed outwards.

When the stick 3 is operated in an arbitrary direction, the stress distribution in the sensor substrate 2 is expressed by a contour combining the contours of the stress distribution on the +X side and the −X side and the contours of the stress distribution on the +Y side and the −Y side. In this case, the stress also concentrates on a portion of the substrate 2 where the lower surface of the fixed part 5 and each strain sensor 7A-7D overlap.

When pressure is applied on the stick 3 and the operating part 4 to +X in the X-axis direction, as above, a tensile strain is generated in the strain sensor 7A existing on the +X side of the X-axis, thereby increasing the resistance value, while a compressive strain is generated in the strain sensor 7C existing on the −X side of the X-axis, thereby reducing the resistance value.

In the strain sensor 7B placed on the +Y side of the Y-axis, the tensile strain is generated in a right (the +X side) portion with reference to the Y-axis, increasing the resistance value, while the compressive strain is generated in a left (the −X side) portion, reducing the resistance value. Similarly, in the strain sensor 7D existing on the −Y side of the Y-axis, the tensile strain is generated in the right (the +X side) portion with reference to the Y-axis, increasing the resistance value, while the compressive strain is generated in the left (the −X side) portion, reducing the resistance value. At this time, the tensile strain and the compressive strain in the strain sensor 7B are generated symmetrically about the Y-axis, so that the increment and the decrement of the resistance values of the strain sensor 7B are canceled each other. Thus, the resistance value of the whole strain sensor 7B remains unchanged. Similarly, the tensile strain and the compressive strain in the strain sensor 7D are generated symmetrically about the Y-axis, so that the increment and the decrement of the resistance values of the strain sensor 7D are canceled each other. Thus, the resistance value of the whole strain sensor 7D remains unchanged.

When pressure is applied on the operating part 4 to tilt the stick 3 in the direction +X of the X-axis, the resistance values of the strain sensors 7A and 7C on the X-axis are changed individually. Accordingly, a voltage value which is obtained by dividing a power supply voltage applied from the power source terminal 11 based on the ratio of changes of the resistance values is output from the X-axis output terminal 13 (the X-side transducer 15A). In the strain sensors 7B and 7D on the Y-axis, furthermore, the resistance values remain unchanged as mentioned above. Thus, the Y-axis output terminal 14 (the Y-side transducer 15B) outputs the same predetermined voltage value as that in the case where the stick 3 and the operating member 4 are not operated. Based on the voltage values output from the X-axis output terminal 13 and the Y-axis output terminal 14, the movement of the cursor K displayed on the LCD 23 of a notebook-sized personal computer 20 mentioned later is controlled.

It is to be noted that each chip resistor 8A-8D is placed outside apart from each strain sensor 7A-7D respectively and is formed with a thicker than each strain sensor 7A-7D, so that a resistance value of each chip resistor will not change even when the sensor substrate 2 is deformed by operation of the operating part of the stick 3 as mentioned above. Thus, the voltage values output from the X-axis output terminal 13 and the Y-axis output terminal 14 exactly respond to the changes in the resistance values of the strain sensors 7A-7D.

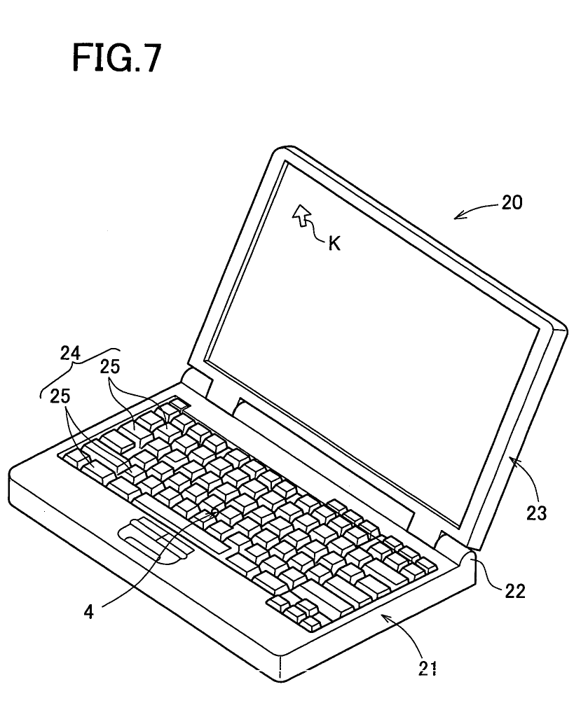

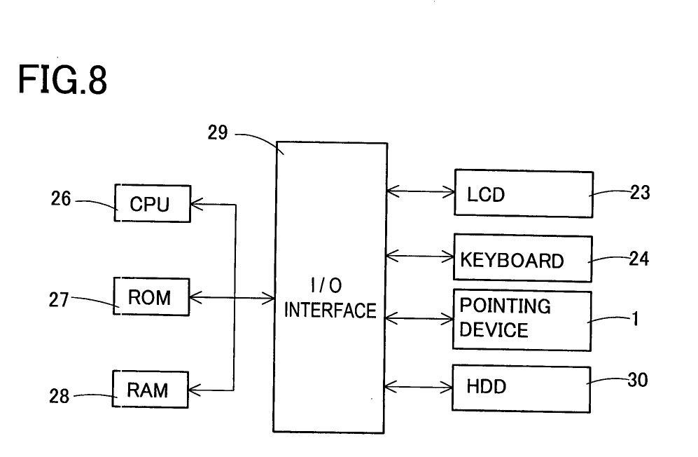

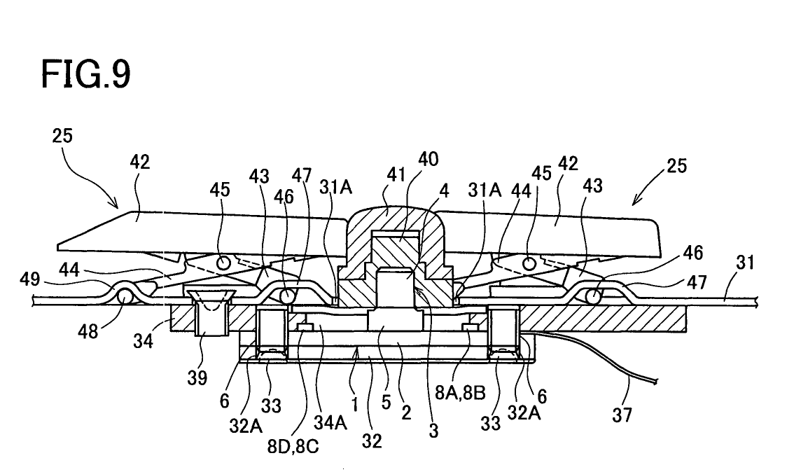

Next, an electronic apparatus mounting the pointing device 1 having the above structure will be explained with reference to FIGS. 7 through 9. In this embodiment, a notebook-sized personal computer is explained as an example of the electronic apparatus. FIG. 7 is a perspective view of the notebook-sized personal computer. FIG. 8 is a block diagram of same. FIG. 9 is a sectional view of the pointing device assembled onto a key switch arrangement plate in the notebook-sized personal computer.

In FIG. 7, a notebook-sized personal computer 20 includes a computer main unit 21 and a liquid crystal display (LCD) 23 which is rotatably supported by a hinge 22 formed in an edge (a rear end) of the main unit 21 so that the LCD 23 is opened/closed with respect to the main unit 21. A keyboard 24 is provided on the upper surface of the main unit 21. This keyboard 24 includes a plurality of key switches 25 arranged on a switch arrangement plate. The structure of each key switch 25 including the switch arrangement plate will be mentioned later. The operating part 4 of the stick 3 of the pointing device 1 is disposed between two of the plurality of key switches 25 arranged on the keyboard 24, the two having upper surfaces on which letters “G” and “H” are printed respectively.

The computer main unit 21 houses a circuit board on which a CPU 26, a ROM 27, a RAM 28, an input/output (I/O) interface 29, and others are provided as shown in FIG. 8. The main unit 21 also houses a hard disk drive (HDD) 30 serving as a recording device. The I/O interface 29 is connected with the LCD 23, the keyboard 24, the pointing device 1, and the HDD 30. The voltage signals output from the X-side transducer 15A and the Y-side transducer 15B in response to the operation of the stick 3 and the operating part 4 are input to the CPU 26 through the I/O interface 29. The CPU 26 executes a cursor moving control program stored in the ROM 27 to calculate a moving direction and a moving amount of the cursor K displayed on the LCD 23 based on the voltage signals output from the X-side and Y-side transducers 15A and 15B, and moves the cursor K on the LCD 23 in accordance with the calculated result. It is to be noted that, if a combination of the voltage signals output from the X-side and Y-side transducers 15A and 15B is a predetermined value or more, which is regarded as representing that a click operation has been performed, a predetermined process is executed.

A structure of mounting the pointing device 1 onto the switch arrangement plate of the keyboard 24 is explained with reference to FIG. 9. In FIG. 9, the pointing device 1 is attached under the key switch arrangement plate 31 disposed on the whole area of the keyboard 24 and key switches 25 are arranged on the upper surface of the key switch arrangement plate 31.

At first, the mounting structure of the pointing device 1 is described. A metallic reinforcing plate 32 is placed on the lower surface of the sensor substrate 2 (on which the strain sensors 7A-7D are formed). The pointing device 1 is attached together with the reinforcing plate 32 to a metallic mounting plate 34 by means of screws 33 inserted in hole 32A of the reinforcing plate 32 and sequentially the holes 6 of the sensor substrate 2. A circuit pattern including the chip resistors 8A-8D formed on the upper surface of the substrate 2 is connected with a lead wire 37. This lead wire 37 is connected with the circuit board on which the CPU 26 and others are provided.

As mentioned above, the mounting plate 34 to which the pointing device 1 is attached is fixed to the lower surface of the switch arrangement plate 31 by tightening a screw 39 from above the upper surface of the plate 31. In this state, the stick 3, as shown in FIG. 9, is placed protruding upward on the upper surface side of the switch arrangement plate 31 through an opening 34A of the mounting plate 34 and an opening 31A of the switch arrangement plate 31. The operating part 4 of the stick 3 is covered by a resinous cap 40 which is further covered by a rubber cap 41. Thus, the operating part 4 of the stick 3 can be operated by a user from above the keyboard 24.

The structure of each key switch 25 arranged on the switch arrangement plate 31 is schematically explained below. Each key switch 25 is provided with a key top 42 and a pair of link members 43 and 44 which guide a vertical motion of the key top 42. The link members 43 and 44 are supported to be mutually rotatable by an axial support part 45. The link member 43 has an upper end (not shown) which is rotatably supported on the lower surface of the key top 42 and a pin 46 provided at a lower end which is slidably supported in a slidably supporting part 47 integrally formed with the switch arrangement plate 31. The other link member 44 has an upper end (not shown) which is slidably supported on the lower surface of the key top 42 and a pin 48 provided at a lower end which is rotatably supported in a rotatably supporting part 49 integrally formed with the switch arrangement plate 31. In each key switch 25 constructed as above, the key top 42 is supported by the pair of link members 43 and 44 rotatably supported by the axial support part 45, so that each key switch 25 can be operated while maintaining a horizontal posture of the key top 42. It is to be noted that the above mentioned structure of each key switch 25 is well known and the details thereof are omitted herein.

In the pointing device 1 in the present embodiment, as explained in detail above, the strain sensors 7A-7D are formed on the sensor substrate 2 in partially indirectly overlapping relation with the lower surface of the fixed part 5 of the stick 3. Accordingly, the portion of the sensor substrate 2 in which the largest stress concentrates when the operating part 4 of the stick 3 is operated overlaps with each strain sensor 7A-7D. The stress generated in the sensor substrate 2 is thus allowed to directly act on each strain sensor 7A-7D, which can detect the operation state of the stick 3 with high sensitivity.

In the above pointing device 1, the trimmable chip resistors 8A-8D are connected in series with the strain sensors 7A-7D respectively. Even where there are changes in the resistance values of the strain sensors 7A-7D, the change in offset voltage caused by the changes in the resistance values of the strain sensors 7A-7D can be canceled by trimming the chip resistors 8A-8D.

Furthermore, in the notebook-sized personal computer 20 mounting the pointing device 1, as described above, the portion of the sensor substrate 2 in which the largest stress concentrates by operation of the stick 3 overlaps with each strain sensor 7A-7D. Accordingly, the stress generated in the sensor substrate 2 can directly act on each strain sensor 7A-7D. Consequently, the operation state of the stick 3 can be detected with high sensitivity. It is therefore possible to operate the stick 3 to accurately move the cursor K displayed on the LCD 23 with good operationality.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A pointing device including:
a sensor substrate;
a stick member including a base part and being arranged upright on the sensor substrate; and
a pair of strain sensors for detecting an operating state of the stick member, the strain sensors being provided on the sensor substrate at positions where a part of each strain sensor overlaps with a lower surface of the base part of the stick member.

2. The pointing device according to claim 1 further including trimmable chip resistors each being connected in series with each strain sensor.

3. An electronic apparatus including:
a main unit on which a keyboard is mounted;
a display part which is connected with an edge of the main unit so that the display part is opened/closed with respect to the main unit; and
a pointing device for moving a cursor displayed on the display part, the pointing device being arranged in the keyboard of the main unit;
wherein the pointing device includes
a sensor substrate;
a stick member including a base part and being arranged upright on the sensor substrate; and
a pair of strain sensors for detecting an operating state of the stick member, the strain sensors being provided on the sensor substrate at positions where a part of each strain sensor overlaps with a lower surface of the base part of the stick member.
